(19) United States
(12) Patent Application Publication
(10) Pub. No.: US 2023/0382323 A1
(43) Pub. Date: Nov. 30, 2023

(54) WIRE HARNESS

(71) Applicant: SUMITOMO WIRING SYSTEMS, LTD., Yokkaichi-shi, Mie (JP)

(72) Inventors: Kosuke TANAKA, Yokkaichi-shi (JP); Katsutoshi IZAWA, Yokkaichi-shi (JP); Ryuta SAITO, Yokkaichi-shi (JP)

(73) Assignee: SUMITOMO WIRING SYSTEMS, LTD., Yokkaichi-shi, Mie (JP)

(21) Appl. No.: 18/027,744

(22) PCT Filed: Jul. 28, 2021
(86) PCT No.: PCT/JP2021/027948

§ 371 Date: Mar. 22, 2023

(30) Foreign Application Priority Data
Oct. 5, 2020 (JP) 2020-168191

(51) Int. Cl. B60R 16/02; H02G 3/04

(52) U.S. Cl. CPC B60R 16/0215; H02G 3/0468

(57) ABSTRACT

A wire harness including: an electric wire; an exterior tube that covers an outer periphery of the electric wire; and a path regulator that extends along a lengthwise direction of the exterior tube while covering a portion in a circumferential direction of an outer periphery of the exterior tube, and regulates a path along which the electric wire is routed.

### BACKGROUND

The present disclosure relates to a wire harness.

Conventionally, a wire harness that includes a corrugated tube that covers the outer periphery of an electric wire member, and a path regulating member that covers a portion in the circumferential direction of the corrugated tube and regulates a path along which the electric wire member is routed is known (for example, see JP 2013-55760A).

The corrugated tube of the wire harness described in JP 2013-55760A includes a slit formed along the lengthwise direction thereof. The path regulating member includes a path retaining member provided along the outer periphery of the corrugated tube, and an attachment member provided in the slit. The attachment member is configured to be engageable with the inner peripheral side portion of the slit and the outer peripheral side portion of the path retaining member. The corrugated tube, the path retaining member, and the attachment member are fixed together by, for example, winding a piece of tape around them, and the path of the electric wire member is thereby regulated.

### SUMMARY

Incidentally, in the wire harness described in JP 2013-55760A, the attachment member is provided in the slit of the corrugated tube. For this reason, there is a risk that a gap will form between the attachment member and the slit. Such a gap is not preferable for increasing the water blocking properties of the wire harness.

An exemplary aspect of the disclosure provides a wire harness that can suppress a decrease in water blocking properties.

A wire harness according to the present disclosure includes: an electric wire; an exterior tube that covers an outer periphery of the electric wire; and a path regulator that extends along a lengthwise direction of the exterior tube while covering a portion in a circumferential direction of an outer periphery of the exterior tube, and regulates a path along which the electric wire is routed, wherein: the path regulator includes: an insertion port that is an opening that extends along the lengthwise direction of the path regulator over an entire length of the path regulator and is configured to enable the exterior tube to be inserted thereinto, a first end and a second end that are positioned on opposite sides to each other in a circumferential direction of the path regulator, and form the insertion port, and a coupler that couples the first end and the second end, a boundary between the coupler and each of the first end and the second end of the path regulator forms a linear folding line extending along the entire length of the path regulator, a shape of the coupler when viewed from the lengthwise direction of the path regulator is an arc that forms a portion of a virtual circle centered at a point on an axis that runs along the lengthwise direction of the path regulator, the coupler has a curvature radius that is larger than that of the exterior tube, and the first end and the second end are bent toward an inner side of the virtual circle and are in contact with an outer surface of the exterior tube. [0008]

According to the present disclosure, it is possible to suppress a decrease in water blocking properties of a wire harness.

### BRIEF DESCRIPTION OF THE DRAWINGS

FIG. 1 is a schematic diagram of a configuration showing a wire harness according to an embodiment of the present disclosure.

FIG. 2 is a cross-sectional view showing the wire harness according to the embodiment.

FIG. 3 is an exploded perspective view showing an exterior member and a path regulating member of the wire harness according to the embodiment when detached from each other.

FIG. 4 is a front view showing the path regulating member according to the embodiment.

FIG. 5 is a front view showing a path regulating member according to a modified example.

FIG. 6 is a front view showing a path regulating member according to a modified example.

### DETAILED DESCRIPTION OF EMBODIMENTS

### Description of Embodiments of Disclosure

First, embodiments of the present disclosure will be listed and described.

[1] A wire harness according to the present disclosure includes:

an electric wire member, a tubular exterior member that covers an outer periphery of the electric wire member, and a path regulating member that extends along a lengthwise direction of the exterior member while covering a portion in a circumferential direction of the outer periphery of the exterior member, and regulates a path along which the electric wire member is routed, the path regulating member includes: an insertion port that is an opening that extends along a lengthwise direction of the path regulating member over the entire length of the path regulating member and is configured to enable the exterior member to be inserted thereinto, a first end portion and a second end portion that are positioned on opposite sides to each other in a circumferential direction of the path regulating member, and form the insertion port, and a coupling portion that couples the first end portion and the second end portion, a shape of the coupling portion when viewed from the lengthwise direction of the path regulating member is an arc that forms a portion of a virtual circle centered at a point on an axis that runs along the lengthwise direction of the path regulating member, the coupling portion has a curvature radius that is larger than that of the exterior member, and the first end portion and the second end portion are bent toward an inner side of the virtual circle and are in contact with an outer surface of the exterior member.

According to the above configuration, the path regulating member can be retrofitted to the outer periphery of the exterior member through the insertion port. In addition, the shape of the coupling portion of the path regulating member when viewed from the lengthwise direction of the path regulating member is an arc that forms a portion of a virtual circle centered at a point on an axis that runs in the lengthwise direction of the path regulating member. In addition, the first end portion and the second end portion provided at two end portions of the coupling portion are curved to the inner side of the virtual circle and come into contact with the outer surface of the exterior member, and thus it is possible to keep the path regulating member from coming loose from the exterior member through the insertion port. For this reason, for example, a slit or the like for attaching the path regulating member to the exterior member does not need to be formed on the exterior member in order to regulate a path of the electric wire member covered by the exterior member. Therefore, it is possible to suppress a decrease in water blocking properties of the wire harness.

[2] Preferably, the shape of the coupling portion is a major arc.

According to the above configuration, the shape of the coupling portion is a major arc, and thus the first end portion and the second end portion can be shaped so as to easily press the exterior member toward the inner surface of the coupling portion.

[3] Preferably, the shape of the coupling portion is a minor arc.

According to the above configuration, the shape of the coupling portion is a minor arc, and thus, compared with a case where the shape of the coupling portion is a major arc, it is possible to increase the lengths in the circumferential direction of the first end portion and second end portion, for example. Thus, for example, it is possible to easily increase the opening width of the insertion port.

[4] Preferably, the thicknesses of the coupling portion, the first end portion, and the second end portion are constant when viewed from the lengthwise direction of the path regulating member.

According to the above configuration, the thicknesses of the coupling portion, the first end portion, and the second end portion are constant when viewed from the lengthwise direction of the path regulating member, and thus the design is simplified, for example. In addition, for example, if the path regulating member is made of metal, the path regulating member can be easily manufactured from a metal plate.

[5] Preferably, the coupling portion includes a protruding portion that extends along the lengthwise direction of the path regulating member and protrudes in a radial direction of the coupling portion.

According to the above configuration, the coupling portion includes the protruding portion that extends along the lengthwise direction of the path regulating member and protrudes in the radial direction of the coupling portion, and thus it is possible to increase the bending rigidity of the path regulating member.

[6] Preferably, the path regulating member is made of resin and has a constant cross-sectional shape when viewed from the lengthwise direction of the path regulating member.

According to the above configuration, the path regulating member is made of resin and has a constant cross-sectional shape when viewed from the lengthwise direction of the path regulating member, and thus, for example, the path regulating member can be easily manufactured through extrusion molding.

[7] Preferably, the path regulating member is made of metal.

According to the above configuration, the path regulating member is made of metal, and thus, for example, when the path regulating member is disposed at a position near a heat source of the vehicle, it is possible to suppress an increase in temperature inside the exterior member, and accordingly, an increase in the temperature of the electric wire member.

[8] Preferably, the exterior member is a corrugated tube that is flexible and is sealed entirely in a circumferential direction of the exterior member.

According to the above configuration, the exterior member can be deformed in accordance with a routing path of the electric wire member. In addition, the exterior member is sealed entirely in the circumferential direction thereof, and thus it is possible to increase the water blocking properties of the exterior member. Therefore, it is possible to increase both the ease of routing of the wire harness and the water blocking properties of the wire harness.

### Description of Embodiments of Disclosure

Specific examples of a wire harness according to the present disclosure will be described below with reference to the drawings. In the drawings, part of a structure may be exaggerated or simplified for convenience of explanation. In addition, the dimensional ratio of each part may differ between drawings. The present disclosure is not limited to these examples, but is defined by the claims and intended to include all modifications within the meaning and scope equivalent to the claims. The term “orthogonal” as used herein includes not only being exactly orthogonal but also being substantially orthogonal within the range in which the functions and effects according to the embodiment are achieved. Also, the terms “circular” and “arc-shaped” as used herein respectively include not only being exactly circular and exactly arc-shaped but also being substantially circular and substantially arc-shaped within the range in which the functions and effects according to the embodiment are achieved.

### Overall Configuration of Wire Harness 10

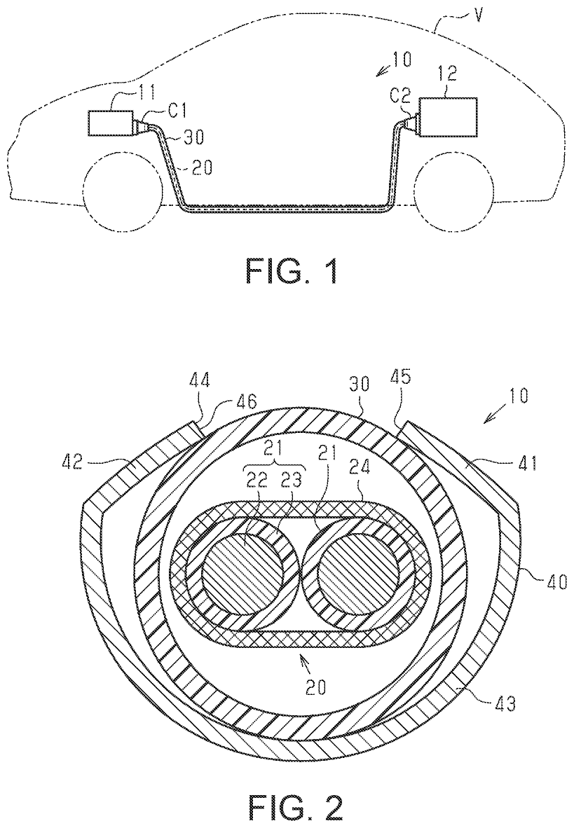

A wire harness 10 shown in FIG. 1 electrically connects two or three or more electric devices. The wire harness 10 electrically connects an inverter 11 installed on the front side of a vehicle V such as a hybrid vehicle or an electric vehicle and a high-voltage battery 12 installed rearward of the inverter 11 in the vehicle V, for example. The wire harness 10 is, for example, routed so as to pass under the floor of the vehicle V. For example, the wire harness 10 is routed so that an intermediate portion of the wire harness in the longitudinal direction thereof extends outside the vehicle interior such as under the floor of the vehicle V.

The inverter 11 is connected to a wheel driving motor (not shown) that is a motive power source for vehicle travel. The inverter 11 generates AC power from DC power of the high-voltage battery 12, and supplies the resultant AC power to the motor.

The high-voltage battery 12 is, for example, a battery capable of supplying a voltage of several hundred volts.

As shown in FIGS. 1 and 2, the wire harness 10 includes an electric wire member 20 (electric wire) that electrically connects the above electric devices, a tubular exterior member 30 (exterior tube) that covers the outer periphery of the electric wire member 20, and a path regulating member 40 (path regulator) that covers the outer periphery of the exterior member 30 and regulates a path (hereinafter, referred to as a “routing path”) along which the electric wire member 20 is routed. A pair of connectors C1 and C2 are respectively attached to two end portions of the electric wire member 20.

### Configuration of Electric Wire Member 20

The electric wire member 20 includes one or more electric wires 21 and a braided member 24 that collectively covers the outer peripheries of the electric wires 21. The electric wire member 20 according to the present embodiment includes two electric wires 21. One end portion of the electric wire member 20 is connected to the inverter 11 via the connector C1, and the other end portion of the electric wire member 20 is connected to the high-voltage battery 12 via the connector C2. The electric wire member 20 is formed in an elongated shape so as to extend in the front-rear direction of the vehicle, for example. The electric wires 21 are high-voltage electric wires that can support a high voltage/large current, for example. Each electric wire 21 may be a non-shielded electric wire that does not have an electromagnetic shield structure, or a shielded electric wire that has an electromagnetic shield structure, for example.

### Configuration of Electric Wires 21

As shown in FIG. 2, the electric wires 21 are coated electric wires that each include a core wire 22 made of a conductor and an insulation coating 23 that covers the outer periphery of the core wire 22.

### Configuration of Core Wire 22

A twisted wire formed by twisting a plurality of metal strands together, a columnar conductor made of a single columnar metal bar that has a solid structure, a tubular conductor that has a hollow structure, or the like can be used as the core wire 22, for example. In addition, for example, a combination of a plurality of types of conductors such as a twisted wire, a columnar conductor, a tubular conductor, and the like can also be used as the core wire 22. Examples of the columnar conductor can include a single core wire, a busbar, and the like. The core wire 22 according to the present embodiment is a twisted wire. A metal material that is copper-based, aluminum-based, or the like can be used as the material of the core wire 22, for example.

A cross-sectional shape (hereinafter, referred to as a “transverse cross-sectional shape”) of the core wire 22 taken along a plane orthogonal to the lengthwise direction of the core wire 22, in other words the lengthwise direction of the electric wire 21 can have any shape. The transverse cross-sectional shape of the core wire 22 has a circular shape, a semicircular shape, a polygonal shape, a square shape, a flat shape, or the like. The transverse cross-sectional shape of the core wire 22 according to the present embodiment is circular.

The term “flat shape” as used herein includes a rectangle, an elongated circular shape, an oval shape, and the like. In addition, the term “rectangle” as used herein refers to a shape that has long sides and short sides, excluding a square. Moreover, the term “rectangle” as used herein includes shapes with chamfered ridge portions and rounded ridge portions. The term “elongated circular shape” as used herein includes a shape that has two parallel lines of substantially the same length and two semicircular shapes.

### Configuration of Insulation Coating 23

The insulation coating 23 covers the entire outer circumference of the outer peripheral surface of the core wire 22, for example. The insulation coating 23 is made of an insulating material such as a synthetic resin. A synthetic resin whose main component is a polyolefin-based resin such as cross-linked polyethylene or cross-linked polypropylene can be used as the material of the insulation coating 23. Also, as the material of the insulation coating 23, one kind of material can be used, or two or more kinds of materials can be used in combination as appropriate.

### Configuration of Braided Member 24

The braided member 24 is formed in a tubular shape so as to collectively cover the outer peripheries of the electric wires 21 as a whole, for example. The braided member 24 is provided so as to cover the outer peripheries of the electric wires 21 over substantially the entire length thereof, for example. A braided wire formed by braiding a plurality of metal strands, or a braided wire formed by braiding a metal strand and a resin strand in combination can be used as the braided member 24. A metal material that is copper-based, aluminum-based, or the like can be used as the material of the metal strand, for example. A highly conductive and shear-resistant reinforced fibers such as para-aramid fibers can be used as the resin strand. Although not illustrated, the braided member 24 is grounded at the connector C1 or C2, or the like.

### Configuration of Exterior Member 30

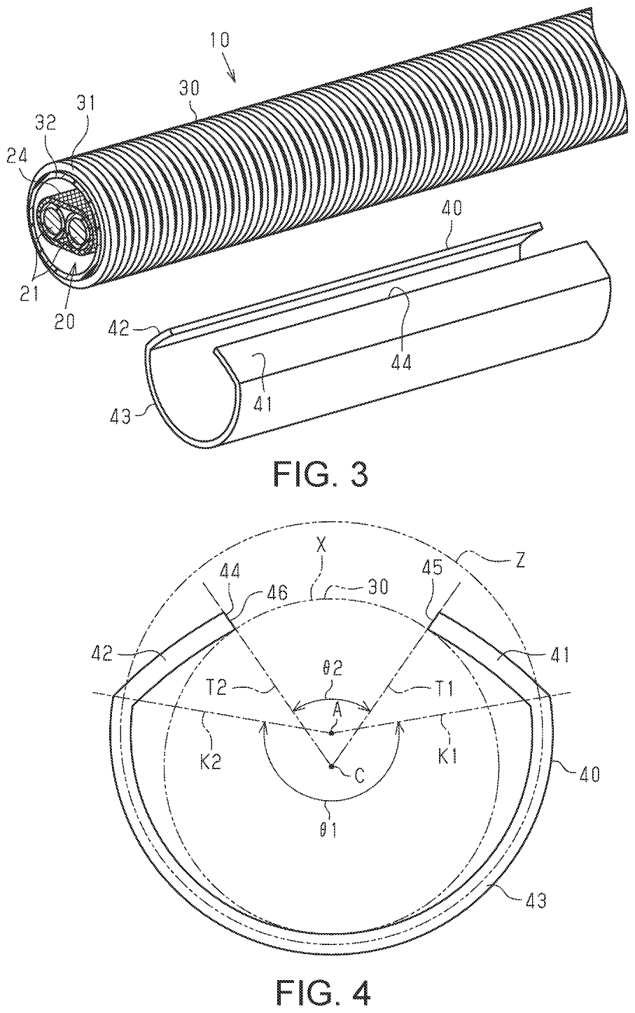

As shown in FIG. 3, the exterior member 30 is formed in a cylindrical shape so as to cover the outer periphery of the electric wire member 20 over the entire circumferential direction thereof. The exterior member 30 is sealed entirely in the circumferential direction. The exterior member 30 is provided so as to cover the outer periphery of a portion in the lengthwise direction of the electric wire member 20, for example. The exterior member 30 according to the present embodiment is a corrugated tube that has a bellows structure in which annular protrusions 31 and annular recesses 32 are alternately provided in a continuous manner along the lengthwise direction of the exterior member 30. The exterior member 30 is flexible.

A conductive resin material or a nonconductive resin material can be used as the material of the exterior member 30, for example. A synthetic resin such as polyolefin, polyamide, polyester, or an ABS resin can be used as the resin material.

### Configuration of Path Regulating Member 40

As shown in FIGS. 2 and 3, the path regulating member 40 covers a portion in the circumferential direction of the outer periphery of the exterior member 30 and extends along the lengthwise direction of the exterior member 30. Note that the path regulating member 40 covers an area that is larger than half of the outer periphery of the exterior member 30. The path regulating member 40 according to the present embodiment is attached to the outer periphery of a portion of the routing path of the electric wire member where the exterior member 30 extends linearly, such as a portion under the floor of the vehicle V.

The path regulating member 40 is made of resin. A synthetic resin such as polypropylene, polyamide, or polyacetal can be used as the material of the path regulating member 40. The path regulating member 40 can be manufactured using a known manufacturing method such as extrusion molding or injection molding. The cross-sectional shape of the path regulating member 40 according to the present embodiment is constant when viewed from the lengthwise direction thereof. The path regulating member 40 is an extrusion-molded component.

The path regulating member 40 includes an insertion port 44 extending in the lengthwise direction of the path regulating member 40, a first end portion 41 and a second end portion 42 that are spaced apart from each other in a direction orthogonal to the length direction of the path regulating member 40 and form the insertion port 44, and a coupling portion 43 (coupler) that couples the first end portion 41 and the second end portion 42. In other words, the path regulating member 40 includes the coupling portion 43 formed so as to cover a portion in the circumferential direction of the exterior member 30, the first end portion 41 and the second end portion 42 provided at two end portions of the coupling portion 43, and the insertion port 44 that is formed by the first end portion 41 and the second end portion 42.

The first end portion 41 and the second end portion 42 are positioned on opposite sides to each other in the circumferential direction of the path regulating member 40. The first end portion 41 and the second end portion 42 are spaced apart from each other, sandwiching the insertion port 44 in the circumferential direction of the path regulating member 40.

The coupling portion 43 is formed in an arc shape having a curvature radius that is larger than that of the exterior member 30. Specifically, as shown in FIG. 4, the shape of the coupling portion 43 when viewed from the lengthwise direction of the path regulating member 40 is an arc that forms a portion of the first virtual circle Z centered at a point A on an axis that runs along the lengthwise direction of the path regulating member 40. The point A on the axis that runs along the lengthwise direction of the path regulating member 40 can be referred to as an “axis that runs along the lengthwise direction of the path regulating member 40”, or can be referred to as a “virtual straight line parallel to the path regulating member 40”. The coupling portion 43 has a curvature radius that is larger than that of the exterior member 30.

The shape of the coupling portion 43 according to the present embodiment is a major arc. That is to say, the shape of the coupling portion 43 is the shape of one of two portions obtained by dividing the first virtual circle Z at two points, the one portion being longer than half the entire circumference of the first virtual circle Z.

In other words, as shown in FIG. 4, when a straight line that extends through the point A and one end portion of the coupling portion 43 is denoted by K1, and a straight line that extends through the point A and the other end portion of the coupling portion 43 is denoted by K2, an angle θ1 formed by the straight line K1 and the straight line K2 on the side on which the coupling portion 43 is present is larger than 180°.

As shown in FIG. 4, the first end portion 41 and the second end portion 42 are configured to be bent toward the inner side of the first virtual circle Z when viewed from the lengthwise direction of the path regulating member 40 and are in contact with the outer surface of the exterior member 30. In other words, the arc shape of the coupling portion 43 follows a portion of the first virtual circle Z, and the first end portion 41 and the second end portion 42 are formed so as to be curved from the coupling portion 43 to the inner side of the first virtual circle Z. The first end portion 41 and the second end portion 42 according to the present embodiment are each formed in an arc shape when viewed from the lengthwise direction of the path regulating member 40. In other words, the first end portion 41 and the second end portion 42 are each shaped as an arc. The lengths of the first end portion 41 and the second end portion 42 are the same when viewed from the lengthwise direction of the path regulating member 40. The thicknesses of the coupling portion 43, the first end portion 41, and the second end portion 42 are constant when viewed from the lengthwise direction of the path regulating member 40.

The insertion port 44 extends along the lengthwise direction of the path regulating member 40 over the entire length of the path regulating member 40. The opening width of the insertion port 44, that is to say, the shortest distance between the first end portion 41 and the second end portion 42 is smaller than the outer diameter of the exterior member 30.

When the exterior member 30 is inserted into the insertion port 44 from a direction orthogonal to the lengthwise direction, the path regulating member 40 elastically deforms, thus increasing the opening width of the insertion port 44. Once the exterior member 30 is inserted into the path regulating member 40, the path regulating member 40 elastically deforms so as to return to its original shape. Accordingly, the above opening width decreases to a width that is smaller than the outer diameter of the exterior member 30, and thus the path regulating member 40 is attached to the exterior member 30. Note that the above opening width does not necessarily return to the exact original width in a state where the exterior member 30 is inserted into the path regulating member 40, and, as a result of elastic deformation that the path regulating member 40 undergoes to return to its original shape being inhibited by the exterior member 30, the opening width may be increased to a width that is slightly larger than the original width. In addition, the above opening width may return to the original width as a result of the exterior member 30 being deflected in a state where the exterior member 30 is inserted into the path regulating member 40. That is to say, the above opening width in a state where the exterior member 30 is inserted into the path regulating member 40 is based on the rigidity, the deflectability, and the like of the exterior member 30 and the path regulating member 40. Note that FIGS. 2 and 4 do not precisely illustrate the state where the exterior member 30 and the path regulating member 40 are deflected in the state where the exterior member is inserted into the path regulating member 40, and schematically illustrate the states of the exterior member 30 and the path regulating member 40.

In the following description, as shown in FIG. 4, a straight line that extends through a central axis line C of a largest second virtual circle X that can be accommodated in the path regulating member 40 when viewed from the lengthwise direction thereof and a leading end 45 of the first end portion 41 is denoted by T1, and a straight line that extends through the central axis line C and a leading end 46 of the second end portion 42 is denoted by T2. Note that the above second virtual circle X is the second virtual circle X with the largest diameter that can be accommodated in the path regulating member 40 in a state where the exterior member 30 is not inserted, and does not necessarily match the outer circumference of the exterior member 30, and FIG. 4 schematically illustrates a state where the second virtual circle X matches the outer circumference of the exterior member 30. In the present embodiment, the diameter of the exterior member 30 is set to be slightly larger than the diameter of the above second virtual circle X.

An opening angle θ2 of the insertion port 44 is preferably within the range of 60 to 120°, for example, in order to attach the path regulating member 40 to the exterior member 30 according to the present embodiment. The opening angle θ2 according to the present embodiment is 70°. The “opening angle θ2” as used herein is an angle formed by the straight line T1 and the straight line T2 mentioned above.

The leading end 45 of the first end portion 41 is formed along the straight line T1. The leading end 46 of the second end portion 42 is formed along the straight line T2. Accordingly, the insertion port 44 is formed such that the opening width increases toward the outer side in the radial direction of the insertion port 44, namely away from the central axis line C.

The first end portion 41 and the second end portion 42 of the path regulating member 40 according to the present embodiment press the exterior member 30 to the inner surface side of the coupling portion 43. Accordingly, the path regulating member 40 is held relative to the exterior member 30.

Functions of the present embodiment will be described.

With the wire harness 10 according to the present embodiment, the path regulating member 40 can be retrofitted to the outer periphery of the exterior member 30 through the insertion port 44. The path regulating member 40 includes the first end portion 41 and the second end portion 42 that are bent toward the inner side of the first virtual circle Z and are in contact with the outer surface of the exterior member 30, and thus it is possible to suppress the path regulating member 40 from coming loose from the exterior member 30 through the insertion port 44.

Functions of the present embodiment will be described.

(1) The shape of the coupling portion 43 of the path regulating member 40 when viewed from the lengthwise direction of the path regulating member 40 is an arc that forms a portion of the first virtual circle Z centered at the point A on an axis that runs along the lengthwise direction of the path regulating member 40. Moreover, the first end portion 41 and the second end portion 42 provided at two end portions of the coupling portion 43 are bent toward the inner side of the first virtual circle Z and are in contact with the outer surface of the exterior member 30, and thus it is possible to keep the path regulating member 40 from coming loose from the exterior member 30 through the insertion port 44. For this reason, a slit or the like for attaching the path regulating member 40 to the exterior member 30 does not need to be formed on an exterior member in order to regulate the path of the electric wire member 20 covered by the exterior member 30. Therefore, it is possible to suppress a decrease in water blocking properties of the wire harness 10.

(2) The shape of the coupling portion 43 is a major arc, and thus the first end portion 41 and the second end portion 42 can be shaped so as to easily press the exterior member 30 toward the inner surface side of the coupling portion 43.

(3) The thicknesses of the coupling portion 43, the first end portion 41, and the second end portion 42 are constant when viewed from the lengthwise direction of the path regulating member 40, and thus the design is simplified, for example.

(4) The path regulating member 40 is made of resin, has a constant cross-sectional shape when viewed from the lengthwise direction of the path regulating member 40, and thus can be easily manufactured through extrusion molding, for example. In other words, the path regulating member 40 is an extrusion-molded component, and thus can be easily manufactured.

(5) The exterior member 30 is a corrugated tube. With such a configuration, the exterior member 30 can be deformed in accordance with a routing path of the electric wire member 20. In addition, the exterior member 30 is sealed entirely in the circumferential direction, and thus it is possible to improve the water blocking properties of the exterior member 30. Therefore, it is possible to improve both the ease of routing of the wire harness 10 and the water blocking properties of the wire harness 10.

### Modified Examples

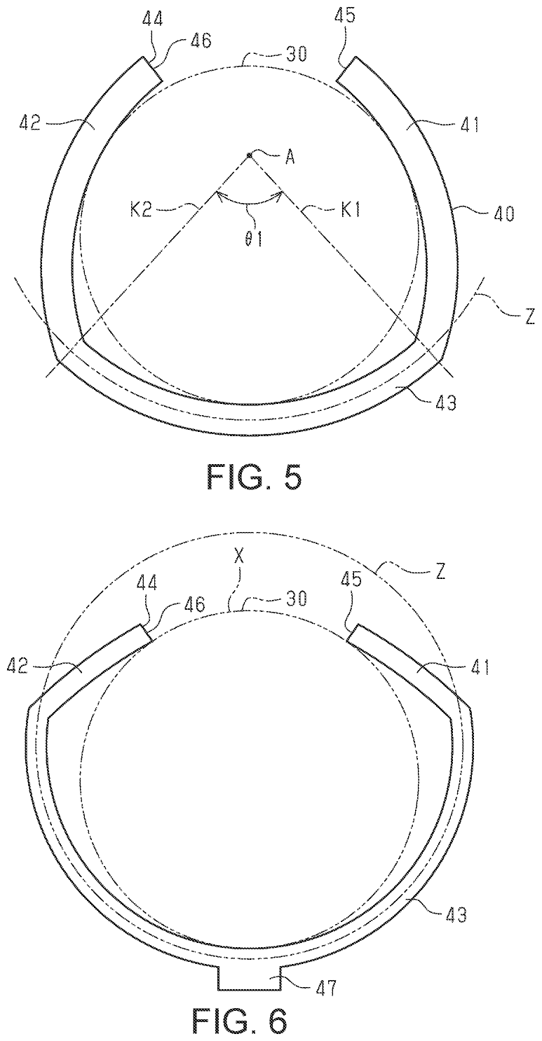

The present embodiment can be modified and implemented as follows. The present embodiment and the modified examples below can be implemented in combination with each other as long as no technical contradictions arise.
In the above embodiment, the shape of the coupling portion 43 is a major arc, but there is no limitation thereto, and, for example, as shown in FIG. 5, the shape of the coupling portion 43 may be a minor arc. That is to say, the shape of the coupling portion 43 shown in FIG. 5 is the shape of one of two portions obtained by dividing the first virtual circle Z at two points, the one portion being shorter than half the entire circumference of the first virtual circle Z. Note that FIG. 5 illustrates, as a virtual line shaped as an arc, only a portion of the first virtual circle Z centered at the point A on an axis that runs along the lengthwise direction of the path regulating member 40.
In other words, as shown in FIG. 5, when a straight line that passes through the point A and one end portion of the coupling portion 43 is denoted by K1 and a straight line that passes through the point A and the other end portion of the coupling portion 43 is denoted by K2, the angle θ1 formed by the straight line K1 and the straight line K2 on the side on which the coupling portion 43 is present is smaller than 180°. With such a configuration, for example, it is possible to increase the length in the circumferential direction of the first end portion 41 and the second end portion 42. Thus, for example, it is possible to make it easier to increase the opening width of the insertion port 44.
In addition, the shape of the coupling portion 43 may be a semicircular arc. In other words, the shape of the coupling portion 43 may be an arc that is the shape of one of two portions obtained by equally dividing the first virtual circle Z.
Note that, in the above embodiment shown in FIG. 4 and the above other example shown in FIG. 5, the path regulating member 40 is formed such that the point A at the center of the first virtual circle Z is inside the path regulating member 40, but there is no limitation thereto, and the path regulating member 40 may be formed such that the point A is outside the path regulating member 40.
A configuration may also be adopted in which, as shown in FIG. 6, the coupling portion 43 has a protruding portion 47 (protrusion) that extends along the lengthwise direction of the path regulating member 40 and protrudes in the radial direction of the coupling portion 43. With such a configuration, it is possible to increase the bending rigidity of the path regulating member 40. Note that a configuration may also be adopted in which the protruding portion 47 is provided along the lengthwise direction of the path regulating member 40 over the entire length of the path regulating member 40, or provided partially in the lengthwise direction of the path regulating member 40. Moreover, the position at which the protruding portion 47 is provided, the number of protruding portions 47, and the shape of the protruding portion 47 may be changed. A protruding portion may be provided at a position on the boundary between the coupling portion 43 and the first end portion 41, for example. A protruding portion may also be provided at a position on the boundary between the coupling portion 43 and the second end portion 42, for example.
In the above embodiment, the first end portion 41 and the second end portion 42 are each formed in an arc shape when viewed from the lengthwise direction of the path regulating member 40, but there is no limitation thereto, and, for example, a configuration may be adopted in which the first end portion 41 and the second end portion 42 are formed in a linear shape.
In the above embodiment, the first end portion 41 and the second end portion 42 have the same length when viewed from the lengthwise direction of the path regulating member 40, but there is no limitation thereto, and a configuration may also be adopted in which the first end portion 41 and the second end portion 42 have different lengths.
In the above embodiment, the thicknesses of the coupling portion 43, the first end portion 41, and the second end portion 42 are constant and the same when viewed from the lengthwise direction of the path regulating member 40, but there is no limitation thereto, and a configuration may also be adopted in which the thicknesses differ. In addition, at least one of the coupling portion 43, the first end portion 41, and the second end portion 42 does not need to have a constant thickness when viewed from the lengthwise direction of the path regulating member 40.
The first end portion 41 and the second end portion 42 may be configured such that the thicknesses thereof gradually decrease toward the leading ends, for example. In addition, the first end portion 41 and the second end portion 42 may also be configured such that the thicknesses thereof gradually increase toward the leading ends, for example.
The path regulating member 40 may be made of metal. The path regulating member 40 may be made of a metal material that is iron-based, copper-based, aluminum-based, or the like. In this case, it suffices for the opening angle θ2 of the insertion port 44, the thickness of the path regulating member 40, and the like to be adjusted such that the path regulating member 40 does not plastically deform, by widening the insertion port 44. With such a configuration, for example, when the path regulating member 40 is disposed at a position near a heat source of the vehicle, it is possible to suppress an increase in temperature inside the exterior member 30, and accordingly, an increase in the temperature of the electric wire member 20. In addition, for example, if the path regulating member 40 is made of metal and the thicknesses of the coupling portion 43, the first end portion 41, and the second end portion 42 are constant, the path regulating member 40 can be easily manufactured by bending a metal plate.
The exterior member 30 may be formed by a metal layer containing a metal material provided on the outer surface of a corrugated tube. Such a metal layer can be provided through plating, for example. It is preferable that the metal layer is provided over all outer surfaces of the annular protrusions 31 and the annular recesses 32 of the corrugated tube. A metal material that has a small radiation factor such as aluminum is preferably used for the outermost surface of the metal layer, for example. With such a configuration, for example, when the exterior member 30 is disposed at a position near a heat source of the vehicle, it is possible to suppress an increase in temperature inside the exterior member 30, and accordingly, an increase in the temperature of the electric wire member 20.
The exterior member 30 may include a slit that extends in the lengthwise direction of the exterior member 30. In this case, the exterior member 30 may be sealed over the entirety in the circumferential direction, for example, by winding tape around the outer periphery of the exterior member 30 so as to block the slit over the entire length of the exterior member 30. Accordingly, it is possible to suppress a decrease in the water blocking properties of the exterior member 30 that includes the slit.
The transverse cross-sectional shape of the exterior member 30 may be a flat shape.
The path regulating member 40 has a configuration in which the first end portion 41 and the second end portion 42 press the outer surface of the exterior member 30, but a configuration can be adopted in which, for example, the outer surface of the exterior member 30 is not pressed, provided that the route of the exterior member 30 can be regulated.
The electric wire member 20 may include one electric wire 21, or may include three or more electric wires 21.
The braided member 24 may be omitted from the electric wire member 20.
The wire harness 10 may include a plurality of path regulating members 40 spaced apart from each other in the lengthwise direction of the exterior member 30.
The path regulating member 40 is not limited to a path regulating member provided under the floor of the vehicle V. The path regulating member 40 may be provided in the vehicle interior of the vehicle V, as long as it is provided at a portion of the routing path of the electric wire member 20 that extends linearly, for example.
In the illustrated example, the coupling portion 43 of the path regulating member 40 is an example of a linear receiving portion that has a receiving surface that is shaped as a recessed curve and is configured to receive a first length portion of the exterior member 30. The first end portion 41 and the second end portion 42 of the path regulating member 40 are examples of a pressing tab that includes a pressing surface that presses the first length portion of the exterior member 30 toward the recessed curved receiving surface of the linear receiving portion that is the coupling portion 43. Each of the pressing tab and the linear receiving portion may be a single component configured to elastically sandwich the first length portion of the exterior member 30.
As in the example shown in FIG. 3, the boundary between the coupling portion 43 of the path regulating member 40 and each of the first end portion 41 and the second end portion 42 of the path regulating member 40 may form a linear folding line extending along the entire length of the path regulating member 40, or be a linear folding line.
As shown in the example shown in FIG. 2, on the inner surface in the radial direction of the path regulating member 40, the boundary between the first end portion 41 and the coupling portion 43 of the path regulating member 40 and/or the boundary between the second end portion 42 and the coupling portion 43 of the path regulating member 40 may be spaced apart from the outer surface in the radial direction of the exterior member 30 with the longest distance possible therebetween.
As shown in the example shown in FIG. 2, the inner surface in the radial direction of the path regulating member 40 and the outer surface in the radial direction of the exterior member 30 may form non-annular spaces such as two symmetrical wedge-shaped spaces therebetween. One of the two wedge-shaped spaces extends along the inner surface in the radial direction of the path regulating member 40 and spreads from the first end portion 41 of the path regulating member 40 toward the coupling portion 43. The other of the two wedge-shaped spaces extends along the inner surface in the radial direction of the path regulating member 40 and spreads from the second end portion 42 of the path regulating member 40 toward the coupling portion 43.
As shown in the example shown in FIG. 2, the coupling portion 43 of the path regulating member 40 can include a receiving surface shaped as a recessed curve or a bottom surface shaped as a recessed curve. The recessed curved bottom surface can have a first curvature radius in a natural state where the path regulating member 40 is not attached to the exterior member 30. The recessed curved bottom surface can have a second curvature radius that is larger than the first curvature radius in an assembled state where the path regulating member 40 is attached to the exterior member 30. The first end portion 41 and the second end portion 42 of the path regulating member 40 can be configured to press the exterior member 30 toward the recessed curved bottom surface of the path regulating member 40. Each of the first end portion 41 and the second end portion 42 of the path regulating member 40 may include an inner surface in the radial direction that may be substantially flat or that can have a third curvature radius larger than the second curvature radius, in both the natural state where the path regulating member 40 is not attached to the exterior member 30 and the assembled state where the path regulating member 40 is attached to the exterior member 30. The inner surfaces in the radial direction of the first end portion 41 and the second end portion 42 of the path regulating member 40 may face the recessed curved bottom surface of the coupling portion 43.
As shown in the example shown in FIG. 1, the wire harness 10 can include at least one linear portion and at least one bent portion. As in the example shown in FIG. 3, the regulating member 40 may be configured to be retrofitted to a predetermined length portion of the exterior member 30, and regulate the predetermined length portion of the exterior member 30 so as to have a straight line shape that matches or corresponds to a linear portion of the wire harness 10.

1. A wire harness comprising:
an electric wire;
an exterior tube that covers an outer periphery of the electric wire; and
a path regulator that extends along a lengthwise direction of the exterior tube while covering a portion in a circumferential direction of an outer periphery of the exterior tube, and regulates a path along which the electric wire is routed, wherein:
the path regulator includes:
an insertion port that is an opening that extends along the lengthwise direction of the path regulator over an entire length of the path regulator and is configured to enable the exterior tube to be inserted thereinto,
a first end and a second end that are positioned on opposite sides to each other in a circumferential direction of the path regulator, and form the insertion port, and
a coupler that couples the first end and the second end,
a boundary between the coupler and each of the first end and the second end of the path regulator forms a linear folding line extending along the entire length of the path regulator,
a shape of the coupler when viewed from the lengthwise direction of the path regulator is an arc that forms a portion of a virtual circle centered at a point on an axis that runs along the lengthwise direction of the path regulator,
the coupler has a curvature radius that is larger than that of the exterior tube, and
the first end and the second end are bent toward an inner side of the virtual circle and are in contact with an outer surface of the exterior tube.

2. The wire harness according to claim 1,
wherein the shape of the coupler is a major arc.

3. The wire harness according to claim 1,
wherein the shape of the coupler is a minor arc.

4. The wire harness according to claim 1,
wherein thicknesses of the coupler, the first end end, and the second end are constant when viewed from the lengthwise direction of the path regulator.

5. The wire harness according to claim 1,
wherein the coupler includes a protrusion that extends along the lengthwise direction of the path regulator and protrudes in a radial direction of the coupler.

6. The wire harness according to claim 1,
wherein the path regulator is made of resin and has a constant cross-sectional shape when viewed from the lengthwise direction of the path regulator.

7. The wire harness unit according to claim 1,
wherein the path regulator is made of metal.

8. The wire harness unit according to claim 1,
wherein the exterior tube is a corrugated tube that is flexible and is sealed entirely in a circumferential direction of the exterior tube.
